(19) United States
(12) Patent Application Publication
(10) Pub. No.: US 2016/0198688 A1
(43) Pub. Date: Jul. 14, 2016

(54) Telescoping Fishing Rod Assembly

(71) Applicant: Steinhauser, L.L.C., Cabot, AR (US)

(72) Inventor: Ralph J. Duda, Battlefield, MO (US)

(21) Appl. No.: 14/994,614

(22) Filed: Jan. 13, 2016

Related U.S. Application Data
(60) Provisional application No. 62/103,541, filed on Jan. 14, 2015.

(51) Int. Cl. A01K 87/02; A01K 87/06; A01K 87/08

(52) U.S. Cl. CPC A01K 87/025; A01K 87/08; A01K 87/06

(57) ABSTRACT

This invention relates to a hollow telescoping fishing rod assembly with an inventive mounting block on the handle that aligns a hollow rod with a fishing reel so that the fishing line port of the reel is axially aligned with the opening in the proximal end of the hollow fishing rod. In some embodiments, the mounting block has a hinging mechanism to provide access to the end of the rod. The rod is segmented and provided with internal ferrules that reduce wear on the fishing line.

### RELATED APPLICATIONS

This application claims priority to United States Provisional Patent Application No. 62/103,541 filed on Jan. 14, 2015, which application is incorporated herein by reference.

### BACKGROUND OF THE INVENTION

The present invention relates to an improved fishing rod. More particularly, the present invention relates to a fishing rod assembly having a telescoping hollow shaft and an axially aligned fishing reel so that the fishing line passes directly through the hollow rod. Moreover, an inventive mounting bracket provides substantial rigidity to the rod and is hinged to allow easy threading of the fishing line through the hollow rod.

Telescoping fishing rods are well known in the industry and have been disclosed in publications and patents for decades. Further, in-line or through line fishing rods, those where the fishing line passes through the rod body itself, are known. Many anglers believe there are advantages to passing a line directly through a fishing rod rather than stringing the rod through ferrules mounted to the rod exterior. These advantages include a substantial reduction in line tangling, ease of casting and reduced rod and line entanglement during storage.

There are several types of telescoping rods, including those with external, or traditional, ferrule arrangements, those with internal devices for reducing line to rod contact, and those with no ferrules at all. A common internal ferrule assembly, particularly in European rods, is a long metal spring that winds along the internal periphery of the rod body. An example of such a rod can be seen at European Patent EP0712572. The spring holds the line off of the rod along the length of the rod. Obviously, such a unitary spring will not work in a telescoping rod since the spring itself will not collapse. Internal ferrules are highly desirable; otherwise the fishing line drags over the entire length of the rod during casting and retrieval of the line.

There are generally two types of line-through-rod assemblies. The first and more prevalent design includes an opening within the periphery of the hollow rod through which fishing line from a line container or reel is passed. These are “offset” line-through-rod assemblies which use a standard rod to reel orientation, for example, with a bait casting reel positioned generally above the rod. This orientation is standard because it is used with the more prevalent fishing rod design, where the line is strung exterior the rod itself, generally passing through a number of ferrules. This orientation for a line-through-rod assembly creates an angle between the fishing line dispensed from a reel and the rod. A significant drawback to this configuration is the significant increase in fishing line wear caused by line rubbing on the opening in the periphery of the rod tube. Line wear is exacerbated by the rubbing of line as it passes from the fishing reel at an angle into the hollow rod. An example of this is shown at U.S. Pat. No. 3,862,509 to Petersen. One advantage of fishing rods of this design is the ease in which a fishing line can be threaded into the hollow rod because the line opening into the rod interior is easily accessible on the periphery, or outer surface of the rod.

In order to reduce fishing line wear, several rods have been developed to align a fishing reel and the hollow rod such that the fishing line passes directly from the reel into the proximal end of the rod thereby decreasing line friction and wear. Examples of fishing rods having this type of orientation include U.S. Pat. No. 5,381,619 to Watkins and U.S. Pat. No. 3, 618,253 to Edwards. Hollow rods that are aligned with the fishing reel do have the advantage of decreased fishing line wear but a significant disadvantage because it can be quite difficult to pass fishing line from the reel through the rod because of the close proximity of the reel to the rod. As can be seen in prior art referenced, the reel is seated in close proximity to the hollow rod opening which is necessary to limit unintended line tangling between the reel and the rod. Accordingly, when it's necessary to reintroduce the line through the rod for any reason, it can be a tedious and frustrating experience to manipulate and maneuver the line into the rod tube.

In embodiments of the instant invention a hollow telescoping fishing rod assembly is provided with a reel seat for axially aligning the reel to the proximal end of the fishing rod. A plurality of inventive ferrules keep the fishing line substantially centered within the rod and also serve as stops at one end of each telescoping segment to prevent unintended disjointment of rod segments. These ferrules allow the rod segments to be selectively collapsed within each successive segment while keeping the segments aligned and connected.

A mounting bracket is provided that substantially increases the rigidity and stability of the rod, substantially decreased manufacturing costs, and in one embodiment allows the rod to be hinged downward with respect to the reel seat for easy line access to the hollow core of the rod. This facilitates easy threading of line through the rod, which is particularly easy when the rod is collapsed.

### SUMMARY OF THE INVENTION

According to its major aspects and general design, the inventive fishing rod assembly comprises a hollow rod having a multiple hollow core segments, with each segment smaller than the preceding segment so that they can be collapsed or retracted substantially within one another in a manner that is generally referred to as “telescoping”. In some embodiments, the segments are substantially cylindrical with open ends. Each segment has an inner surface and an outer surface. Each segment slides along the length of the next larger section so that they “nest” within one another. Each segment is hollow and has an opening at each end of the segment. In some embodiments, the cross-section of the segments may decrease in diameter from the proximal to the distal end of each segment. An innovative ferrule is mounted at a proximal end of each segment. Each ferrule includes an annular sleeve portion that slides within the hollow end of a rod segment and is generally fastened in place using common mounting methods such as crimping, adhesive or via mechanical fasteners. An eye ring is formed integrally with the sleeve and projects outward from the periphery of the outer surface of the sleeve at one end thereof. Because each segment is a different diameter to accommodate nesting of the segments, each ferrule must also be a different size. The outer diameter of each ferrule must be slightly smaller than the inner diameter of the rod segment into which it nests. A stopping band or collar 140 is provided on the outer periphery of each rod segment end opposite the end where the ferrule is mounted. The stopping bands are wide enough so that they engage the end edge of the preceding rod segment as the rod segments are collapsed. This stops the smaller segments from being pushed through the larger segments as the segments are collapsed.

A mounting bracket is provided for securing the rod portion to a reel seat that orients the reel, when fastened to the seat, in axial alignment with the opening in the proximal end of the hollow rod so that line passed linearly from the reel into the inner core of the rod. In a first embodiment the mounting bracket comprises a lightweight pair of tubes fastened together. The upper tube generally comprises the rod mounting structure and the lower tube generally comprises the reel seat mounting structure. A bridge between the upper tube and lower tube defines the distance or height between the rod and the reel seat. This bridge can be manufactured in any size to accommodate virtually any size rod and reel combination so that the line opening of the reel can always be axially aligned with the rod. Accordingly, for larger reels to be mounted to the inventive device, a larger bridge is provided between the upper and lower mounting tubes to increase the offset distance between the rod and the reel seat.

The lower tube for mounting the reel seat can be presented with or without threads. Accordingly, a reel seat can be fastened to the lower tube in a manner similar to the rod fixation to the upper tube. Many reel seats, however, may be presented with threads which are generally used in association with a moveable securing screw to fasten the reel into the reel seat. In that regard, the lower mounting tube can be provided with mateable threads so that the reel seat can easily be screwed into the lower mounting tube. In this first embodiment, the mounting bracket is rigid and the dimensions of the mounting bracket define the distance between the core of the fishing rod and the reel seat.

It is understood that the orientation of the upper tube and lower tubes of the mounting block can be reversed to accommodate an open-faced spinning reel assembly such that the reel seat is positioned above the rod core or in a generally downward and customary fashion. The mounting bracket may include a storage compartment in the lower tube for storing a small line threading tool, or other small fishing accessories. The storage compartment includes an appropriate closure that can be retained by friction or presented with threads that mate to opposing threads provided in the lower tube of the mounting bracket.

It is understood that the mounting block assembly can be manufactured from virtually any suitable material, including plastic, fiberglass, aluminum, metal alloys and composite materials.

In a second embodiment of the invention, the mounting block includes a hinged portion integral with or substantially adjacent to the bridge member. The hinge portion allows the upper mounting tube to be partially offset respective the lower mounting tube along a direction dictated by the hinge orientation. In the preferred embodiment, this hinge mechanism functions much like the breaking mechanism on a double barrel shotgun. The mechanism allows the upper mounting block tube to move generally forward with respect to the lower mounting tube thereby raising the rod opening upward above the fishing reel mounted in the fishing reel seat. This allows a user easy access to the core of the hollow fishing rod for threading replacement line through the rod. As any person familiar with the use of a rod and reel knows, it is quite common for line to break, become worn, kinked, coiled or twisted thereby requiring replacement. The inventive hinged mounting block allows easy access to the rod core for threading through replacement line. Further, the inventive mounting block may include a closeable compartment in which a line threading tool may be stored. This line threading tool may be as simple as a small weight that can be clamped onto the end of the fishing line and then dropped through the core of the hollow rod.

Accordingly, in use, when it is necessary to replace line through the rod, the hinge mechanism of the mounting block is actuated thereby moving the top tube up and away from the lower tube exposing the fishing line opening of the rod. The line is then passed through the rod, with or without the assistance of a threading tool, and when that is achieved the hinge mechanism of the mounting block is closed thereby realigning the core of the rod with the fishing reel line opening.

The hinge mechanism of the mounting block can be provided with a securing pin or other device that locks the hinge into place when not in use. This prevents inadvertent movement of the top mounting tube to the lower mounting tube as the rod is cast.

The end of the rod adjacent the fishing reel can be provided with a flange or expanded collar to reduce the amount of line exposed between the reel and the rod during operation. The collar can also assist in threading replacement line into the rod.

In this second embodiment, it is preferred that the mounting block be manufactured from aluminum due to its high strength and low weight. Moreover, repeated usage of the hinge mechanism can unduly wear plastics and other light and nondurable materials.

Other features and advantages of the present invention may be apparent to those skilled in the art upon a review of this patent, in light of the detailed description, claims and drawings herewith.

### BRIEF DESCRIPTION OF THE DRAWINGS

FIG. 1 is a side view of a first embodiment of the fishing rod assembly.

FIG. 2 is a top view of the first embodiment of the fishing rod assembly depicting the telescoping rod in a retracted configuration.

FIG. 3A is a side view of the first embodiment of the fishing rod assembly depicting the telescoping rod in a retracted configuration.

FIG. 3B is a perspective view of a portion of the first embodiment of the fishing rod assembly.

FIG. 4A is a partial exploded view of an embodiment of the fishing rod assembly.

FIG. 4B is a perspective view of the internal ferrules used in an embodiment of the fishing rod assembly.

FIG. 4C is a partial cross-sectional view of an embodiment of the fishing rod assembly depicting internal ferrules with the telescoping rod in a partially retracted configuration.

FIG. 4D is a partial cross-sectional view of an embodiment of the fishing rod assembly depicting the internal ferrules with the telescoping rod in a fully retracted configuration.

FIG. 4E is a partial cross-sectional view of an embodiment of the fishing rod assembly depicting the stop collars with the telescoping rod in a retracted configuration.

FIG. 4F is a partial cross-sectional view of an embodiment of the fishing rod assembly on the axis 4F-4F depicted on FIG. 4C.

FIG. 4G is a partial cross-sectional view of an embodiment of the fishing rod assembly on the axis 4G-4G depicted on FIG. 4D.

FIG. 4H is a partial cross-sectional view of an embodiment of the fishing rod assembly on the axis 4H-4H depicted on FIG. 4E.

FIG. 5 is a partial side view of an embodiment of the fishing rod assembly.

FIG. 6 is a partial perspective view of an embodiment of the fishing rod assembly.

FIG. 7 is a partial side view of an embodiment of the fishing rod assembly depicting a hinged mounting bracket.

### DETAILED DESCRIPTION OF THE INVENTION

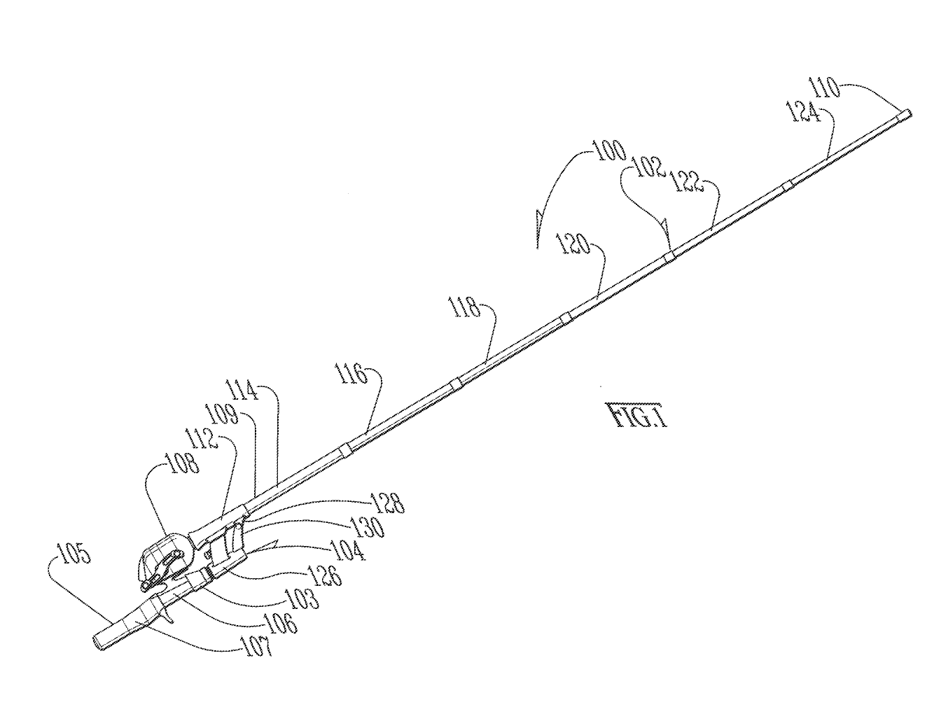

Referring now generally to FIGS. 1, 2, and 3A, an extended side, top, and retracted side view of a first embodiment of the telescoping fishing rod assembly 100 is depicted. The fishing rod assembly 100 includes a rod 102, a handle 105 having a reel seat 106 and grip area 107. A rod bracket 104 connects the rod 102 to the handle 105. In some embodiments of the assembly 100, the rod 102 is a telescoping rod. The reel seat 106 of the handle 105 is provided with reel seat bracket 103 for securing to the reel seat 106 to hold the reel 108 in a manner that is similar to a typical fishing rod. The handle 105 extends past the reel seat area 106 to provide a grip area 107 for a user to hold the fishing rod assembly 100 during use.

The rod bracket 104 has a handle mount 126 for attaching to the handle 105, and a rod bracket 104 for attaching to the rod 102. In some embodiments, the rod bracket 104 may be formed as a part of the handle 105 while in other embodiments it may be attached thereto. The handle mount 126 is connected to rod bracket 104 by one or more support members extending between the rod mount and the handle mount. In varying embodiments described in relation to the figures, some of the support members may be rigid, pivoting, or attached on only one end to provide additional support to a pivoting support member.

The rod 102 is fastened to the rod mount 112 on the rod bracket 104 to offset the center of the rod 102 from the handle 105. In some embodiments, the rod mount 112 is hollow to allow a fishing line to pass from reel 108 into the proximal end 109 of rod 102. In some embodiments, the rod mount 112 is a tube that is capable of receiving the proximal end 109 of the rod 102. In those embodiments, the rod 102 is secured within the rod mount 112 by glue, set screw, fasteners, friction fit or other means of attachment. In some embodiments, the rod 100 may be attached to the top of rod mount 112 or secured in a groove therein, or a number of other configurations.

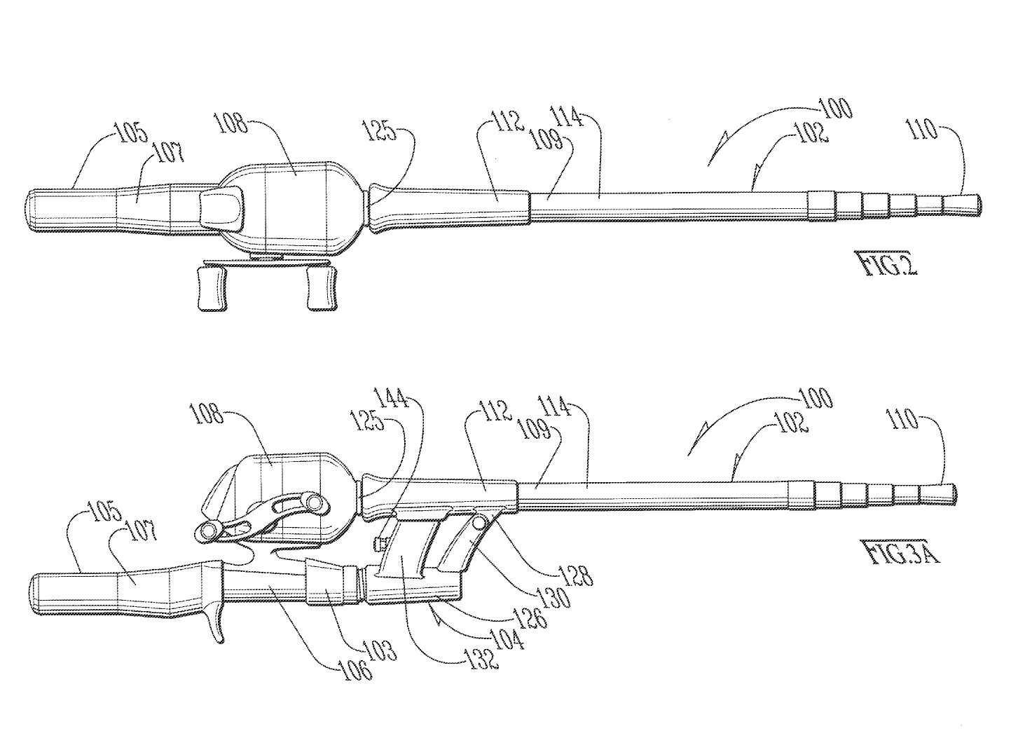

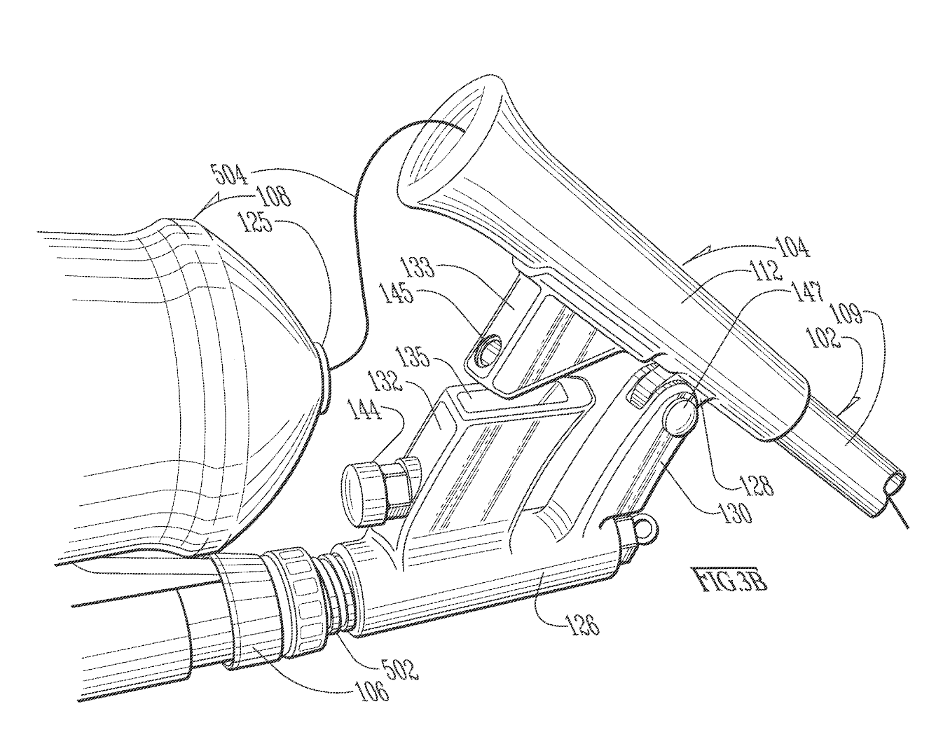

The rod 102 comprises one or more hollow or tubular segments such as segments 114, 116, 118, 120, 122 and 124, where each segment is smaller in diameter than the preceding segment so that they can be collapsed, or nested, substantially within one another in a manner that is generally referred to as “telescoping”. The segments are open at each end to allow a fishing line to pass from one segment to the next along the length of rod 102. The largest or proximal rod segment 114 is fixed in place by its connection to the rod mount 112 at the proximal end 109 of the rod 102. Each successive segment, 114, 116, 118, 120, 122, and 124, is slidably disposed within the adjacent larger hollow segment so that they “nest” within one another when collapsed, as shown in FIGS. 2 and 3A. The last segment 124 terminates in the open distal end 110 of rod 102. The number of segments, or exact configuration of the segments, is not limiting of the invention, and some embodiments may incorporate more or fewer segments than the depicted embodiments. In other embodiments the segments may not be telescoping but may be separable from the adjacent segments to allow it to be folded. Each segment has a proximal or first end that is disposed nearer to the proximal end 109 of rod 102, and a distal or second end that is disposed nearer to the distal end 110 of the rod 102.

As can be seen most clearly in FIGS. 1 and 3A, the rod bracket 104 aligns the rod mount 112 and rod 102 with the port 125 on reel 108 so that the port 125 is in close proximity to the open proximal end of rod 102 as it is disposed within rod mount 112. This allows fishing line to be cast from and reeled back into reel 108 directly through hollow rod 102. Referring still to FIGS. 1 and 3A, an embodiment of the assembly 100 having a pivoting rod bracket 104 is depicted. In the depicted embodiment, the rod bracket 104 comprises the rod mount 112, a handle mount 126 for attaching to the distal end of the handle 105, a first pivot mount 128 fixed to the handle mount, and a second pivot mount 130 fixed to the rod mount 112. The first pivot mount 128 is pivotally attached to the second pivot mount 130 by a pin, bolt, or other means of pivotal attachment. The pivotal movement allows the proximal end 109 of rod 102 to be pivoted away from handle 105 and from reel 108. This configuration, generally shown in FIG. 7 with a different embodiment, allows access to the open proximal end 109 of rod 102 and to port 126 of reel 108, so that a fishing line can be fed from the reel 108 into rod 102. In some embodiments, the first or second pivot mounts 128 and 130, or both, may be provided with stops to limit the range of pivotal motion of the rod bracket 104.

Not all fishing reels 108 have ports 125 as shown in the figures. For example, open face reels or spinning reels may not have a cover over the reel with a port 125. In such cases, the port 125 is the area on the reel 108 from which line is to be dispensed based on the design of that reel. Such an area may be defined by guide wires or the hub of the reel, or in some other manner suitable for that reel design. With respect to the claimed invention, port 125 refers to the area of the reel from which fishing line is released when a cast is made by the user of the reel.

In the depicted embodiment, a support member 132 extends from and is attached to rod mount 112 toward handle mount 126. The support member 132 provides additional support to the rod 102 when the rod is pivoted toward the reel 108 in the closed position shown in FIGS. 1 and 3A. In some embodiments, the support member 132 may be attached to handle mount 126 instead of rod mount 112. In some embodiments such as depicted in FIG. 3B, the support member 130 is pivotally attached to a pivot bracket 128 attached to the rod mount 112 by a pivot bolt 147. In other embodiments, the pivot bracket 146 and bolt 147 may be replaced with a ball joint, a hinge, a barrel joint, or any other mechanism for providing a pivoting motion in at least one axis.

In some embodiments such as that shown in FIG. 3B, a second support member is provided on the handle mount to provide additional support to the rod mount 112. In the depicted embodiment, the additional support comprises a female support member 132 that is provided on either the rod mount 112 or the handle mount 126. The female support member 132 has a socket 135 for receiving a male support member 133 attached to the other mount, 112 or 126, opposed to the female support member 132. The male support member 133 engages the socket in female support member 132 when the rod is pivoted to the closed position. The male support member 133 may be provided with a retention socket 145 for receiving a retractable retention pin 144 disposed in female support member 132. The pin 144 may be retracted to allow the male support member 133 to be fully inserted into the female support member 132, and then inserted into socket 145 to secure the male support member 133 in the socket 135 of female support member 132. The pin 144 may be biased with a spring or other methods of holding the pin 144 in the inserted position when a user has not retracted it.

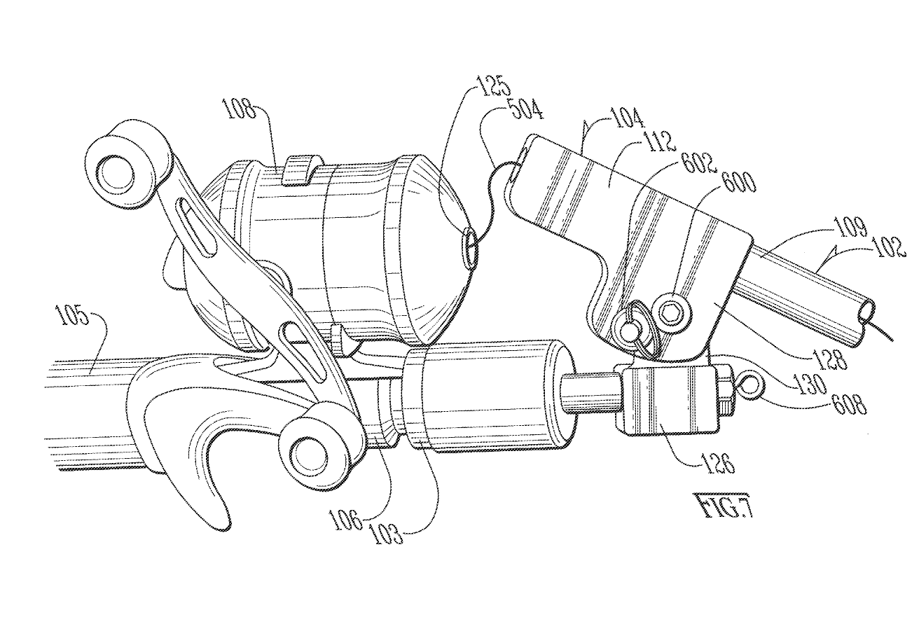

In some embodiments, the first and second pivot mounts 128 and 130, or both, or the support members 132 and 133 may be provided with a pin, detent, or other mechanism to lock the pivot mounts 128 and 130 into a desired position, such as in the closed position shown in FIGS. 1 and 3. In some embodiments such as shown in FIGS. 6 and 7, the locking mechanism comprises a retractable pin provided in one of the pivot mounts 128 or 130, disposed to retractably engage a socket on the other pivot mount 128 or 130 when the pivot mounts are in the closed position depicted in FIGS. 1 and 3. A user may pull the pin to disengage the socket and allow the pivot mounts to be pivoted to an open position. In other embodiments such as shown in FIG. 3B, the locking mechanism comprises a retractable pin mounted in the female support member 132 and extending into a socket in the male support member 133. When the pin is retracted away from female support member 132 the male support member 133 is free to be pivoted away from the female support member 132. When the pin is released, a spring or other similar mechanism may automatically retract the pin and cause it to engage the socket in male support member 133 thus locking the two support members 132 and 133 together.

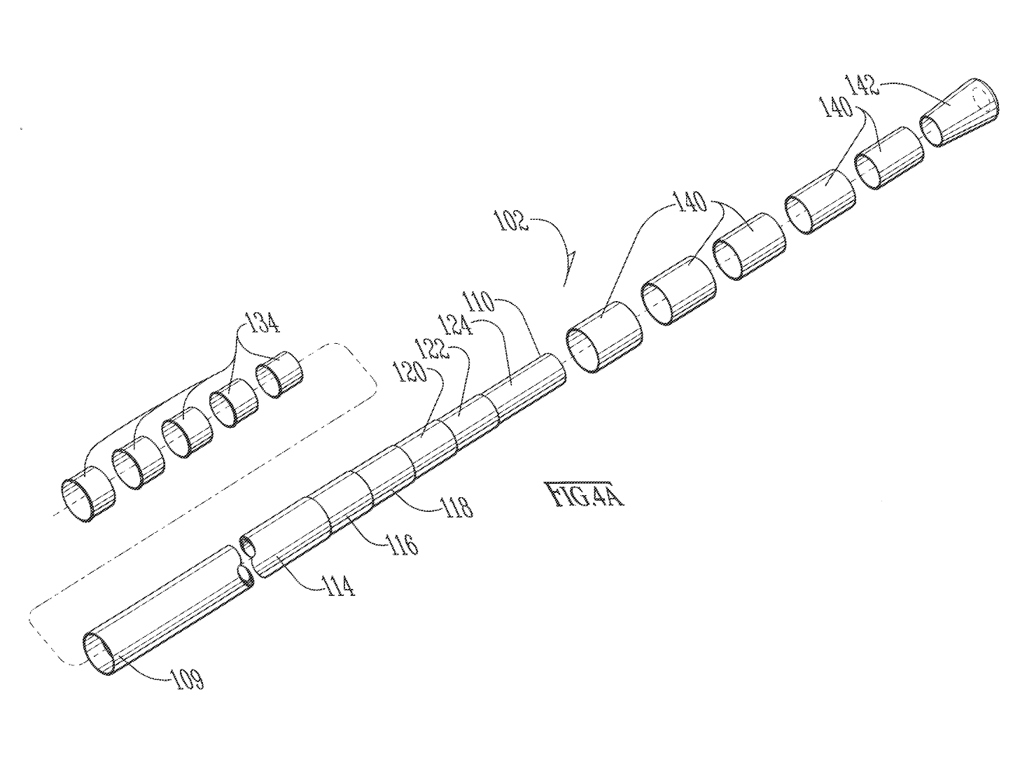

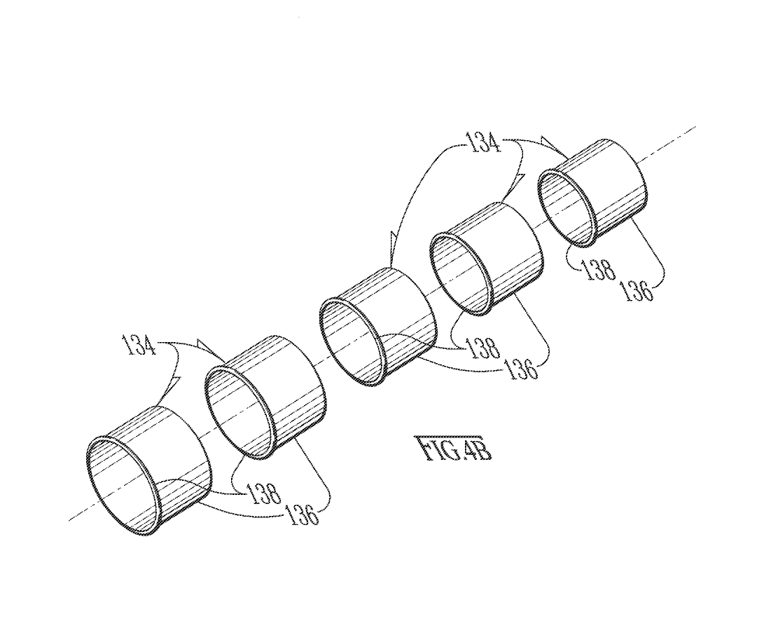

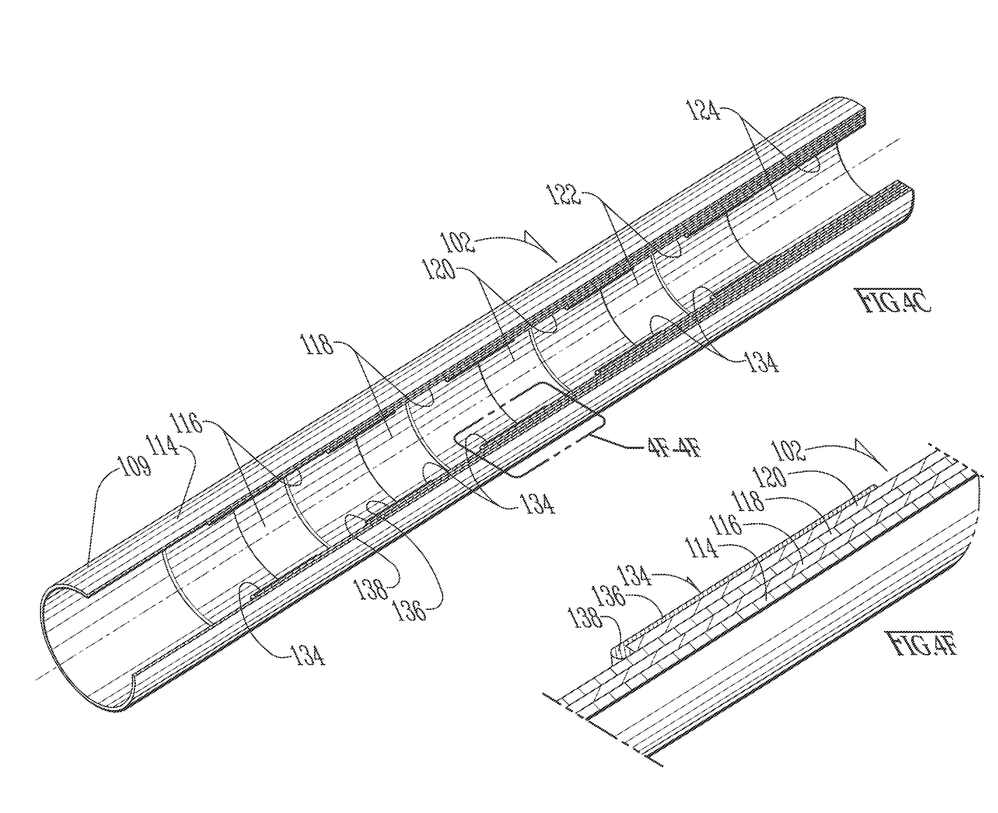

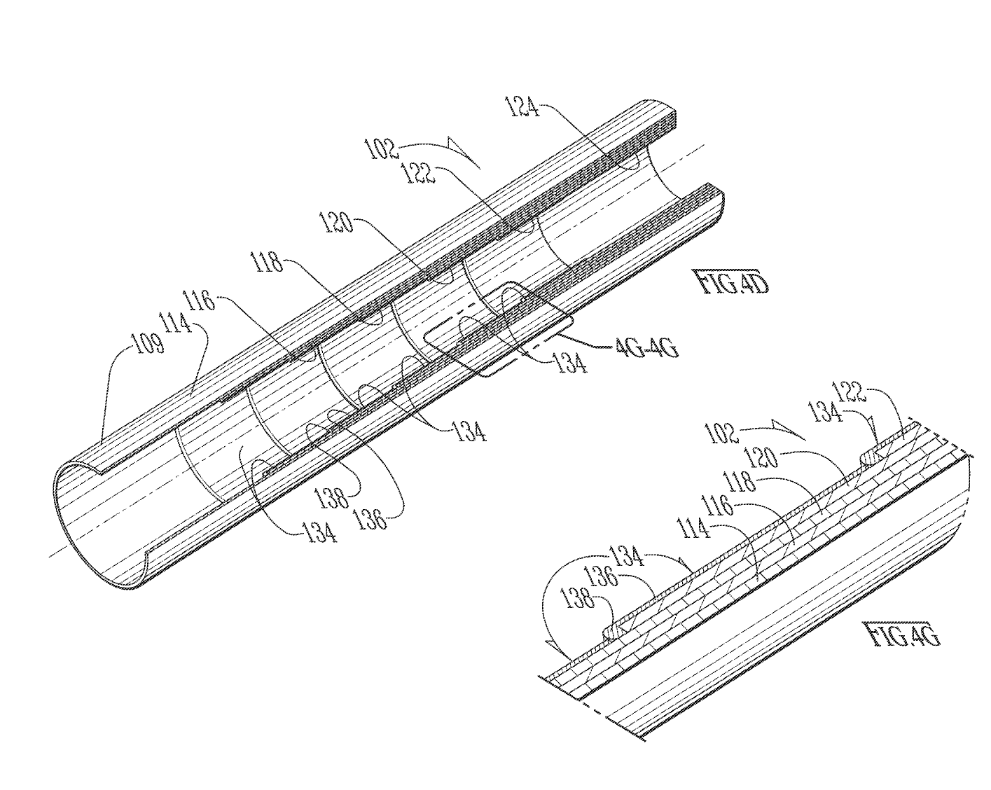

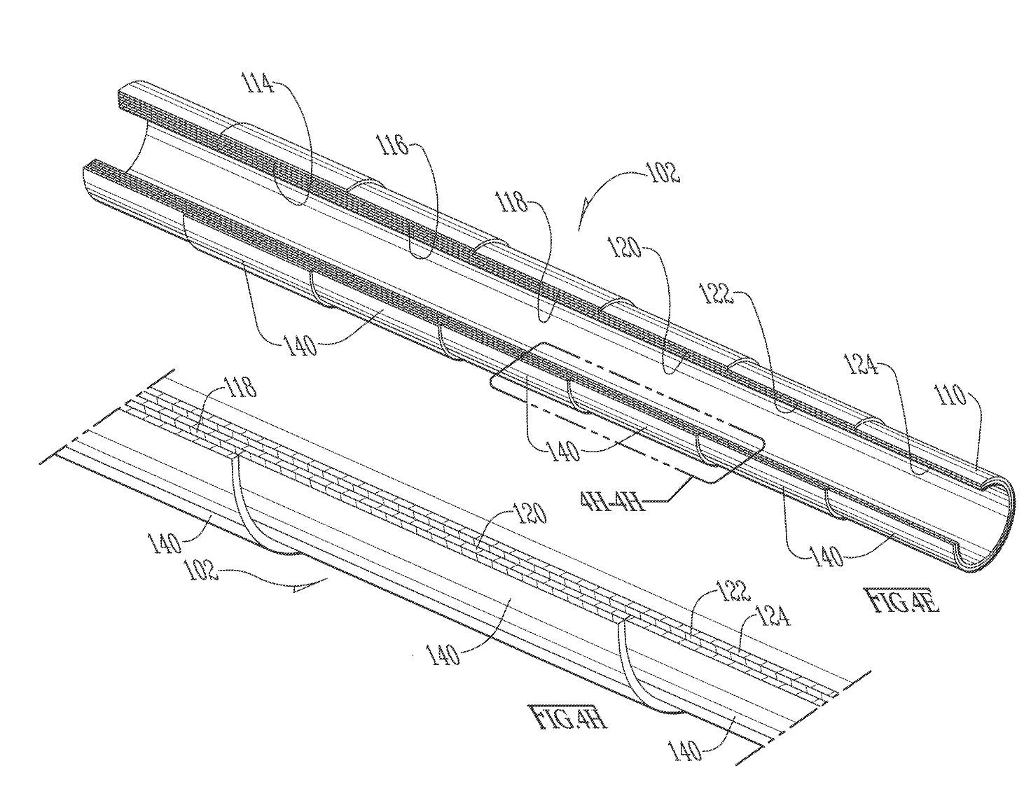

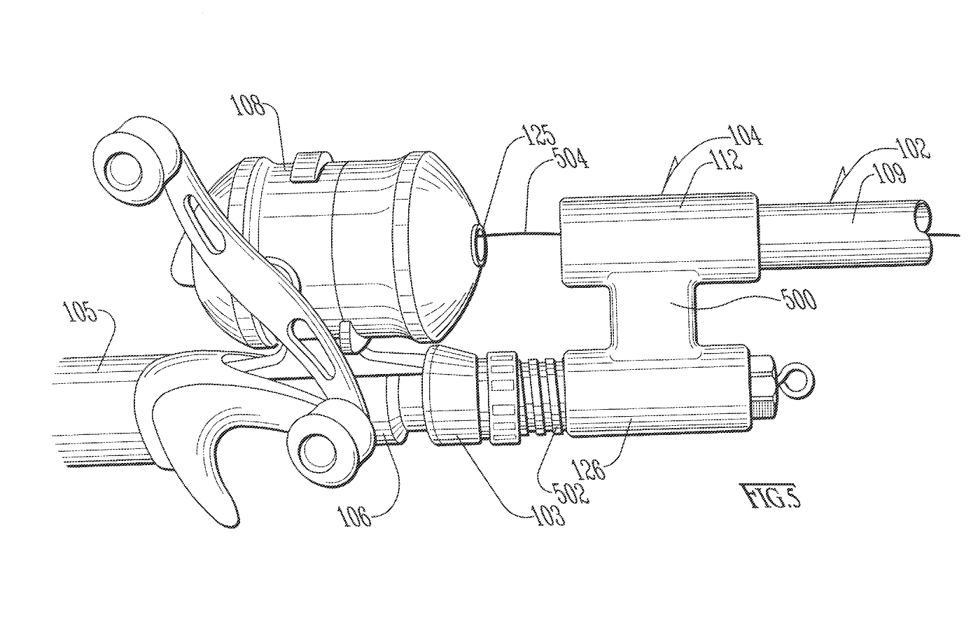

Referring now to FIG. 4A, a partially exploded view of rod 102 is depicted. The rod segments 114, 116, 118, 120, 122, and 124 are depicted in the retracted, nested configuration. A ferrule 134 is mounted on the inside of each segment at the first or proximal end of each segment 114, 116, 118, 120, 122, and 124. As depicted in FIG. 4B, each ferrule 132 includes an annular sleeve 136 portion that slides within the hollow first, or proximal, end of each rod segment and is generally fastened in place using common mounting methods such as crimping, adhesive or via mechanical fasteners. A collar 138 is formed integrally with the sleeve 136 and projects generally outward from the periphery of the outer surface of the sleeve 136. The collar 138 overlaps the proximal end of each segment of rod 102 to protect fishing line in the rod 102 from being damaged by contact with the ends of each segment. Because each segment of rod 102 is a different diameter to accommodate nesting of the segments, each ferrule 134 must also be a different size. The outer diameter of the sleeve portion 136 of each ferrule 134 must be slightly smaller than the inner diameter of the rod segment into which it nests as shown in FIGS. 4C and 4D, which show the rod 102 in a partially retracted cross-sectional view and a fully retracted cross-section view, respectively. The collar portion 138 extends over the thickness of the wall of each segment and fits within the larger rod segment in which that segment is nested. FIGS. 4F and 4G depict detailed cross-sectional views of the cross-sections of FIGS. 4C and 4D, respectively.

As shown in FIGS. 4A and 4E, stopping bands or collars 140 are provided on the outer periphery of the second, or distal, end of each rod segment. The walls of the stopping bands 140 are of similar thickness to the walls of the rod segments so that they engage the end edge of the preceding rod segment as the rod segments are collapsed as shown in FIG. 4E. This engagement stops the smaller segments from being pushed through the larger segments as the segments are collapsed. As best shown in FIG. 4A, the ferrules 126 and stopping bands 132 are sized to each successive rod segment 114, 116, 118, 120, 122, and 124. A tip 142 may also be provided on the distal end of rod 102 to protect the fishing line from damage from the end of rod 102. Detailed cross-sectional views of the fishing rod segments, collars and ferrules are depicted in FIGS. 4H along the axis 4H-4H shown on FIG. 4E.

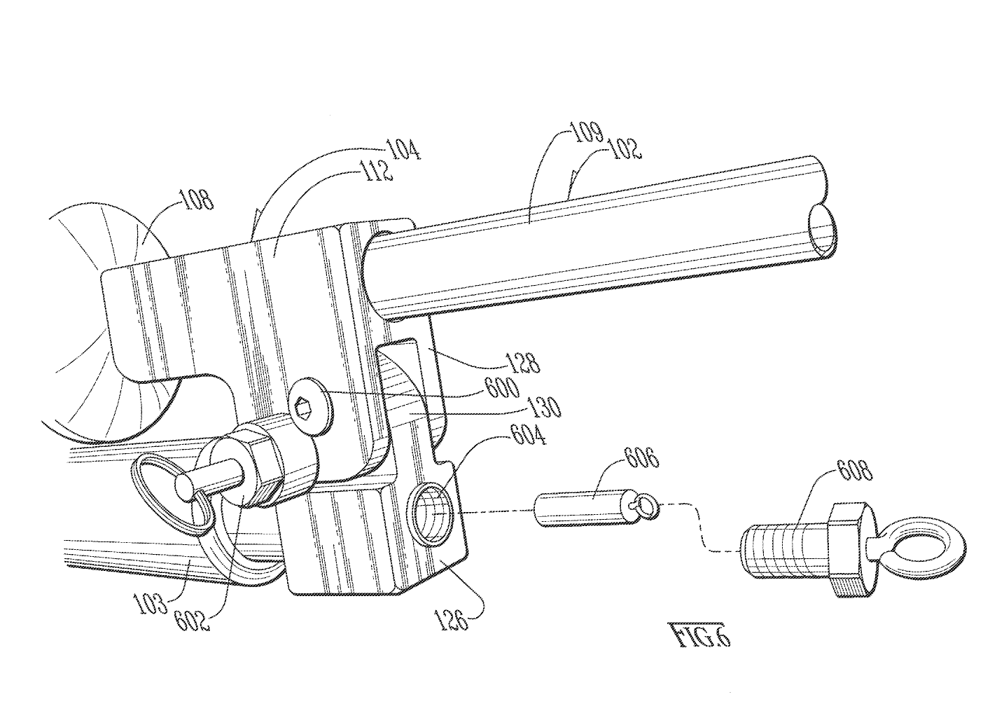

Referring now to FIG. 5, a side view of a portion of another embodiment of the fishing rod assembly is depicted. Fishing line 504 from the fishing reel 108 is passed through the hollow fishing rod 102. In this embodiment, the rod bracket 104 comprises a rod mount 112 for receiving the proximal end of the rod 102, a support member 500, and a handle mount 126. The support member 500 defines the spacing between the rod mount 112 and the handle mount 126. The length of the support member 500 may be altered to accommodate different rod and reel size combinations. In this depicted embodiment the bracket 104 is rigid and does not pivot.

The rod mount 112 and handle mount 126 may comprise tubes in some embodiments, and may be threaded to accommodate a variety of handles 105 and rods 102. In some embodiments, the reel seat 106 of handle 105 may be provided with threads which are used to secure the reel 108 to the reel seat 106 by reel seat bracket 103.

In some embodiments, the rod mount 112 is not threaded and receives the distal end 109 of a hollow fishing rod 102 that is mounted therein using an adhesive, set screw, crimping or using other methods common in the industry. In some embodiments, the handle mount 126 may be threaded to engage threads 502 on reel seat 106. In the embodiment depicted in FIG. 5, the bracket 104 is rigid and does not pivot as the embodiment shown in FIGS. 1-4E. When mounted in the reel seat 106, the reel 108 is generally in axial alignment with the rod 102 and specifically the port 126 of the reel 108 is axially aligned with the proximal end 109 of the hollow rod 102 so that the fishing line 504 passes from the port 126 linearly inside the rod 102.

In some embodiments the orientation of the handle mount 126 and rod mount 112 may be reversed to accommodate either a bait casting reel as shown in FIG. 5, or an open-face spinning reel depending generally downward below the reel seat 106.

Referring now to FIGS. 6 and 7, partial perspective views of another embodiment of the fishing rod assembly 100 are depicted. In the depicted embodiment, the rod bracket 104 is provided with a hinging mechanism that allows the proximal end 109 of the rod to be moved generally upward with respect to the fishing reel 108. The depicted hinging mechanism is a pin or bolt 600 disposed through holes in the first and second pivot mounts 128 and 130. It is understood that other similar hinging mechanisms can be substituted for the hinging mechanism described herein without departing from the spirit and scope of this patent.

To actuate the hinge mechanism for access to the fishing line port 125, the retention pin 602 is disengaged from the retention pin bore which allows the two pivot mounts 128 and 130 to pivot around the pin 600. The range of movement of the pivot mounts 128 and 130 may be limited by the shape of the pivot mounts or by stop détentes formed into the pivot mounts. This hinging operation allows easy access by the user to the fishing line opening 125 of the reel 108 and the open end of hollow rod 102. This accommodates threading new or replacement line from the fishing reel 108 through the rod 102.

The rod mount 112 and handle mount 126 may be sized or threaded to accommodate a variety of rods 102 and reel seats 106. Reel seats 106, such as the one shown in the figures, are provided with threads which are used to secure the reel seat bracket 103 to the reel seat 106, thus securing reel 108 to handle 105. Generally, the rod mount 112 is not threaded to allow a hollow fishing rod 102 to be mounted therein using an adhesive, crimpling, set screw or other methods common in the industry. The handle mount 126 may be threaded depending on the type of reel seat 106 being used. When mounted in the reel seat 106, the reel 108 is generally in axial alignment with the rod 102 and specifically the line orifice of the reel 108 is axially aligned with the open distal end 109 of the rod 102 so that the fishing line passes from the reel 108 substantially linearly into the rod 102.

In one embodiment of the invention, shown in FIGS. 6 and 7, a compartment 604 is provided within the handle mount 126 to house a small fishing line threading tool 606. The threading tool 606 may be a weight that is clamped or tied onto the line or otherwise fastenable to the fishing line and then dropped through the hollow tube of the fishing rod 102. A closure for the compartment such as bolt 608 may be provided. This closure may be threaded to engage threads in the compartment 604, or a friction fit plug or other suitable closing or stopping device.

The inner surface of the hollow fishing rod 102 may be treated or coated with friction reduction material, such as Teflon.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

It will become apparent to those skilled in the art that many changes and substitutions can be made to the preferred embodiments herein described without departing from the spirit and scope of the present invention which is defined by the claims presented herein.

What is claimed is:

1. A fishing rod assembly for use with a fishing reel, the fishing rod assembly comprising:
a fishing rod, said rod comprising a plurality of hollow segments provided in linear alignment, wherein each segment has a different diameter such that each segment can be fitted into an adjacent segment, each segment having an open first end and a spaced apart open second end, an annular ferrule fastened to the inner surface of the first end of each segment and a stopping collar attached to the outer surface of the second end of each segment;
a handle comprising a grip and a a reel seat bracket for receiving the fishing reel;
a rod bracket having a handle mount and a rod mount, the handle mount connected to the rod mount by at least one support member;
wherein the handle mount is attached to the handle and the rod mount is attached to a proximal end of the rod;
wherein the rod bracket offsets the fishing rod from the handle so that the proximal end of the fishing rod is in axial alignment with the fishing reel.

2. The fishing rod assembly of claim 1 wherein the rod mount comprises a tube into which the proximal end of the hollow fishing rod is mounted, and the handle mount comprises a spaced apart tube into which the reel seat bracket is mounted, wherein the rod mount and handle mount are spaced apart a predetermined distance so that a fishing line orifice of the fishing reel is axially aligned with the proximal end of the fishing rod.

3. The fishing rod assembly of claim 1 wherein the rod bracket further comprises a hinge mechanism whereby the rod mount can be pivoted with respect to the handle mount.

4. The fishing rod assembly of claim 3, wherein the hinge mechanism comprises an upwardly projecting first pivot mount extending from the handle mount, a second pivot mount depending from the rod mount, and a pin pivotally attaching the first and second pivot mounts.

5. The fishing rod assembly of claim 4, further comprising a first support member attached to and extending from the handle mount toward the rod mount for providing support to the rod mount.

6. The fishing rod assembly of claim 5, wherein the first support member is a female support member having a socket disposed therein, and a male support member attached to and extending from the rod mount toward the female support member; wherein the male support member engages the socket of the female support member.

7. The fishing rod assembly of claim 6, wherein a retention socket is disposed in the male support member, a retention pin extendably disposed through the female support member to engage the retention socket when the male support member is disposed within socket of the female support member to secure the male support member within the socket.

8. The fishing rod assembly of claim 1, further comprising a closeable compartment formed within the handle mount.

9. The fishing rod assembly of claim 1 wherein each segment tapers from a larger diameter at the first end to a smaller diameter at the second end, and each successive rod segment has successively smaller ferrules and stop rings.

10. The fishing rod assembly of claim 9 wherein each ferrule further comprises a sleeve portion and a collar portion, wherein the collar portion projects generally inward to form a rest for fishing line passing through the hollow rod segments.
